(19) United States
(12) Patent Application Publication
(10) Pub. No.: US 2015/0069961 A1
(43) Pub. Date: Mar. 12, 2015

(54) WIRELESS CHARGING DEVICE

(71) Applicant: Primax Electronics Ltd., Taipei (TW)

(72) Inventor: Chih Hung Chen, Taipei (TW)

(73) Assignee: Primax Electronics Ltd., Taipei (TW)

(21) Appl. No.: 14/076,497

(22) Filed: Nov. 11, 2013

(30) Foreign Application Priority Data
Sep. 6, 2013 (TW) 102132220

(51) Int. Cl. H02J 7/02

(52) U.S. Cl. CPC H02J 7/025
USPC 320/108

(57) ABSTRACT

A wireless charging device for charging an electronic device is provided. Thee wireless charging device includes an adjustable bracket assembly and a wireless charging body. The wireless charging body is disposed on the adjustable bracket assembly. The adjustable bracket assembly includes a first bracket and a second bracket, wherein a relative position between the first bracket and the second bracket is adjustable. When a relative position between the first bracket and the second bracket is adjusted, a position of the electronic device supported on the adjustable bracket assembly is changed. Consequently, the wireless charging body is aligned with the electronic device to perform an efficient wireless charging operation on the electronic device.

### FIELD OF THE INVENTION

The present invention relates to a wireless charging device, and more particularly to a wireless charging device having a mechanism for adjusting the position of an electronic device to be charged.

### BACKGROUND OF THE INVENTION

For providing electric power to an electronic device, the electronic device usually has a built-in chargeable battery. In case that the residual electricity quantity of the chargeable battery within the electronic device is insufficient, the chargeable battery may be charged by a charging device. The conventional charging device comprises a power adapter and a connecting wire. After the power adapter is plugged into a power source and the connecting wire is plugged into the electronic device, an electric current may be transmitted from the conventional charging device to the electronic device through the connecting wire. However, the use of the conventional charging device still has some drawbacks. For example, before the electronic device is charged by the conventional charging device, the electronic device and the connecting wire have to be held by both hands of the user, respectively. In such way, the connecting wire may be plugged into the electronic device. Moreover, after the charging operation is completed, the electronic device and the connecting wire should still be held by the both hands of the user, respectively. In such way, the connecting wire may be pulled from the electronic device. In other words, the use of the conventional charging device for performing the electronic device is not user-friendly.

For solving the drawbacks from the wired charging technology of using the connecting wire, with increasing development of a wireless charging technology, a wireless charging device for wirelessly charging the electronic device has been introduced into a market. FIG. 1 is a schematic view illustrating a conventional wireless charging device. As shown in FIG. 1, the conventional wireless charging device 1 comprises a casing 10, a power cable 11, and an inductive transmitter coil 12. In the conventional wireless charging device 1, a part of the power cable 11 is exposed outside the casing 10 in order to be connected with a power socket (not shown) to acquire electric power. The inductive transmitter coil 12 is disposed within the casing 10. After the electric current from the power socket is transmitted through the power cable 11, the electric current may flow through the inductive transmitter coil 12 to result in an electromagnetic effect. Due to the electromagnetic effect generated by the inductive transmitter coil 12, an inductive receiver coil 21 of a portable electronic device 2 generates an inductive current to charge the chargeable battery (not shown) within the portable electronic device 2.

Generally, the charging efficiency of the wireless charging technology is highly dependent on the situation whether the center of the inductive receiver coil 21 and the center of the inductive transmitter coil 12 are aligned with each other. Since the portable electronic devices 2 in the market are diversified and the shapes and sizes of the portable electronic devices 2 are usually distinguished, the commercially available wireless charging devices 1 are designed according to their matched types of portable electronic devices 2. In other words, the wireless charging devices 1 are capable of charging a specified portable electronic device 2, but fail to be used to charge another unmatched type of portable electronic devices 2 because the alignment is usually unsatisfied.

Since the center of the inductive receiver coil of the unmatched type of portable electronic devices and the center of the inductive transmitter coil 12 cannot be precisely aligned with each other, the charging efficiency of the unmatched type of portable electronic devices is deteriorated, or the unmatched type of portable electronic devices are ineffectively charged by the wireless charging devices 1.

In addition to the above drawbacks, the conventional wireless charging device still has some other drawbacks. For example, the conventional wireless charging devices are usually classified two types, i.e. a horizontal wireless charging device and a vertical wireless charging device. Nowadays, the supporting frame capable of supporting both of the horizontal wireless charging device and the vertical wireless charging device has not been introduced into the market. In other words, the supporting frame cannot be selectively used for the horizontal wireless charging device or the vertical wireless charging device. Moreover, as mentioned above, the charging position of the vertical wireless charging device for charging the electronic device is determined according to the matched type of electronic device. In other words, the charging position is fixed. If an unmatched type of electronic device is charged by the vertical wireless charging device, the charging position is not optimal.

Therefore, there is a need of providing an improved wireless charging device in order to obviate the above drawbacks.

### SUMMARY OF THE INVENTION

The present invention provides a wireless charging device for effectively charging electronic devices with different sizes.

In accordance with an aspect of the present invention, there is provided a wireless charging device for charging an electronic device. The electronic device includes an inductive receiver coil. The wireless charging device includes an adjustable bracket assembly and a wireless charging body. The adjustable bracket assembly is used for supporting the electronic device. The adjustable bracket assembly includes a first bracket and a second bracket. The wireless charging body is disposed on the adjustable bracket assembly, and includes an inductive transmitter coil. A relative position between the first bracket and the second bracket is adjustable. When the relative position between the first bracket and the second bracket is adjusted, a position of the electronic device supported on the adjustable bracket assembly is changed, so that the inductive transmitter coil of the wireless charging body is aligned with the inductive receiver coil of the electronic device to perform a wireless charging operation.

In an embodiment, the first bracket includes a first engaging structure, the second bracket includes plural second engaging structures, and the first engaging structure is engageable with a specified second engaging structure of the plural second engaging structures. An altitude of the electronic device supported on the adjustable bracket assembly is determined according to the specified second engaging structure.

In an embodiment, the first engaging structure includes a supporting part and a notch part, and the plural second engaging structures are plural grooves. When one of the plural grooves is clamped by sidewalls of the notch part, the supporting part of the first engaging structure is protruded over a surface of the second bracket, and an included angle is formed between the first bracket and the second bracket, so that the adjustable bracket assembly is in a supporting state.

In an embodiment, the plural grooves are in parallel with each other.

In an embodiment, the second bracket includes a receiving space, and the wireless charging body is detachably disposed within the receiving space. When the adjustable bracket assembly is in the supporting state to support the electronic device, the electronic device is supported by the supporting part of the first engaging structure, and the electronic device leans against the wireless charging body and at least one of the second bracket.

In an embodiment, the first bracket further includes a protrusion structure. When the first bracket is stacked on the second bracket, the protrusion structure of the first bracket and the receiving space of the second bracket are coupled with each other, so that the adjustable bracket assembly is in an easy-to-carry state.

In an embodiment, the wireless charging device further includes an anti-slip structure. The anti-slip structure is formed on a surface of the supporting part of the first engaging structure.

In an embodiment, the first bracket includes a first coupling part, and the second bracket includes a second coupling part. When the first bracket is stacked on the second bracket, the first coupling part and the second coupling part are coupled with each other, so that the adjustable bracket assembly is in an easy-to-carry state.

In an embodiment, the first bracket includes a protrusion structure, and the second bracket includes a receiving space. The wireless charging body is detachably disposed within the receiving space. Moreover, the first coupling part is the protrusion structure, and the second coupling part is the receiving space.

In an embodiment, both of the first bracket and the second bracket are slabs.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a conventional wireless charging device;

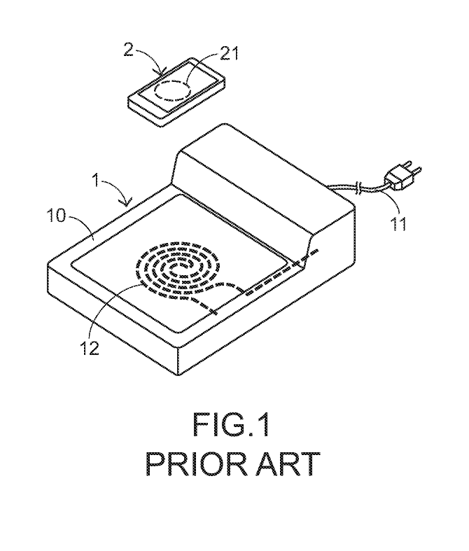

FIG. 2 is a schematic exploded view illustrating a wireless charging device in a first assembling mode;

FIG. 3 is a schematic perspective view illustrating the assembled structure of the wireless charging device in the first assembling mode;

FIG. 4 is a schematic perspective view illustrating an electronic device supported by the wireless charging device in the first assembling mode;

FIG. 5 is a schematic exploded view illustrating a wireless charging device in a second assembling mode; and

FIG. 6 is a schematic perspective view illustrating the assembled structure of the wireless charging device in the second assembling mode.

### DETAILED DESCRIPTION OF THE PREFERRED EMBODIMENT

The present invention provides a wireless charging device. The wireless charging device is used for wirelessly charging an electronic device. Since the wireless charging technology is widely used and well known in the art, the principles of generating the inductive current by an inductive receiver coil of the electronic device are not redundantly described herein.

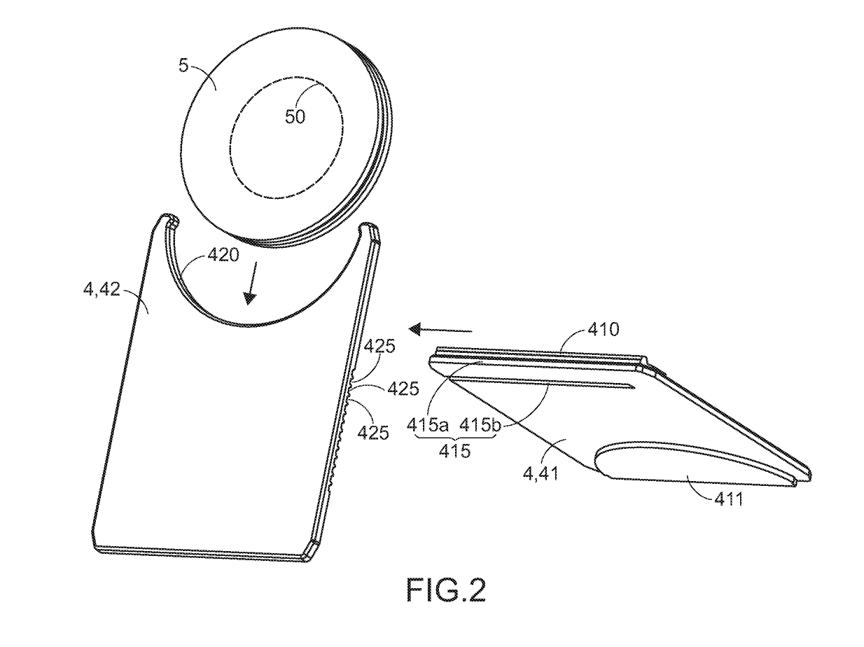

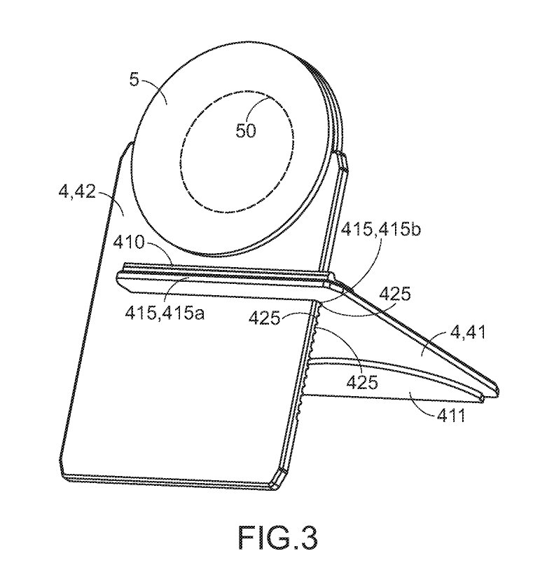

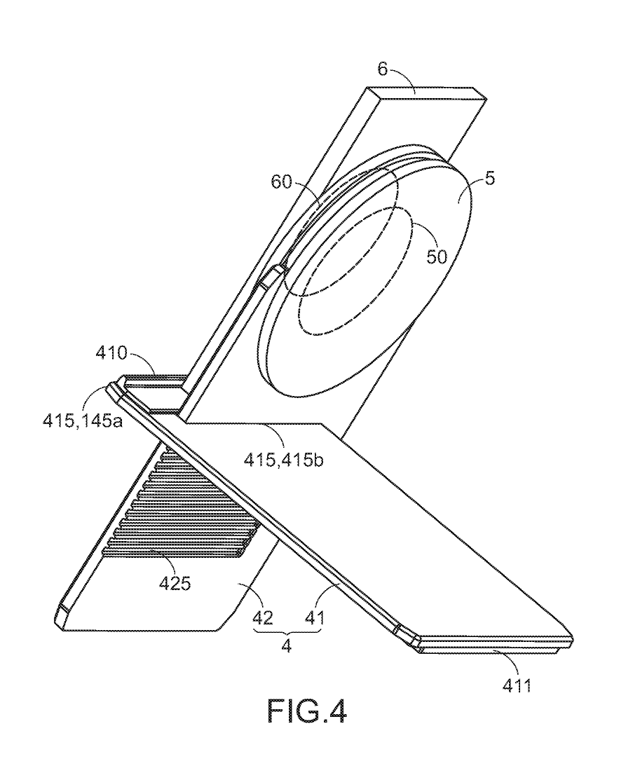

Please refer to FIGS. 2, 3 and 4. FIG. 2 is a schematic exploded view illustrating a wireless charging device in a first assembling mode. FIG. 3 is a schematic perspective view illustrating the assembled structure of the wireless charging device in the first assembling mode. FIG. 4 is a schematic perspective view illustrating an electronic device supported by the wireless charging device in the first assembling mode.

The wireless charging device of the present invention comprises an adjustable bracket assembly 4 and a wireless charging body 5. The wireless charging body 5 is disposed on the adjustable bracket assembly 4 and coupled with the adjustable bracket assembly 4. When an electronic device 6 is supported by the adjustable bracket assembly 4 (see FIG. 4), the electronic device 6 can be aligned with the wireless charging body 5 on the adjustable bracket assembly 4. Consequently, a wireless charging operation may be performed on the electronic device 6. The detailed principles will be illustrated later.

The adjustable bracket assembly 4 comprises a first bracket 41 and a second bracket 42. The first bracket 41 and the second bracket 42 are detachably coupled with each other. In addition, the relative position between the first bracket 41 and the second bracket 42 is adjustable. According to the practical requirements, the user may change the relative coupling position between the first bracket 41 and the second bracket 42 in order to indirectly adjust the altitude of the electronic device 6 that is supported on the adjustable bracket assembly 4.

The wireless charging device of the present invention may be operated in the first assembling mode and a second assembling mode. In case that the wireless charging device is operated in the first assembling mode, the adjustable bracket assembly 4 is in a supporting state. In case that the wireless charging device is operated in the second assembling mode, the adjustable bracket assembly 4 is in an easy-to-carry state.

Hereinafter, the operations of the wireless charging device operated in the first assembling mode will be illustrated with reference to FIGS. 2, 3 and 4. The first bracket 41 comprises a first engaging structure 415, and the second bracket 42 comprises plural second engaging structures 425. As shown in FIG. 2, the first engaging structure 415 is not engaged with the second engaging structures 425. Moreover, the first engaging structure 415 comprises a supporting part 415a and a notch part 415b. In this embodiment, the second engaging structures 425 are plural grooves. After the first bracket 41 is coupled with the second bracket 42 in the arrow direction of FIG. 2, the adjustable bracket assembly 4 is assembled. The resulting assembled structure of the adjustable bracket assembly 4 is shown in FIG. 3. Similarly, after the wireless charging body 5 is coupled with the second bracket 42 in the arrow direction of FIG. 2, the wireless charging body 5 is detachably disposed within a receiving space 420 of the second bracket 42. Moreover, when the user intends to carry the wireless charging device, the wireless charging body 5 may be detached from the adjustable bracket assembly 4. Consequently, the wireless charging device can be carried more easily.

As shown in FIG. 3, one of the plural second engaging structures 425 is clamped by the sidewalls of the notch part 415b of the first engaging structure 415. In addition, the supporting part 415a of the first engaging structure 415 is protruded over a surface of the second bracket 42. As shown in FIG. 4, the electronic device 6 may be supported on the supporting part 415a of the first engaging structure 415. Under this circumstance, since the first bracket 41 and the second bracket 42 intersect each other, an included angle is formed between the first bracket 41 and the second bracket 42 and the adjustable bracket assembly 4 is in a supporting state.

More especially, in the wireless charging device of the present invention, the notch part 415b of the first engaging structure 415 may engaged with any second engaging structure 425 of the plural second engaging structures 425 according to the practical requirements. Consequently, the altitude of the electronic device 6 supported on the adjustable bracket assembly 4 may be adjusted by the user. After the altitude of the electronic device 6 supported on the adjustable bracket assembly 4 is adjusted, the electronic device 6 supported on the adjustable bracket assembly 4 can be aligned with an inductive transmitter coil 50 of the wireless charging body 5 more precisely. Under this circumstance, the inductive transmitter coil 50 of the wireless charging body 5 is located at an optimal charging position to achieve high wireless charging efficiency.

In the wireless charging device of this embodiment, both of the first bracket 41 and the second bracket 42 are slabs, and the notch part 415b is a notch that is formed in the slab of the first bracket 41. The plural grooves of the second engaging structures 425 are in parallel with each other. Consequently, a sidewall of the notch part 415b of the first bracket 41 may be slid into a selected groove of the second bracket 42. When the adjustable bracket assembly 4 is in the supporting state to support the electronic device 6, the supporting part 415a of the first bracket 41 is disposed under the electronic device 6 to withstand the weight of the electronic device 6. At the same time, the backside of the electronic device 6 may lean against the wireless charging body 5 individually, lean against the second bracket 42 individually, or lean against both of the wireless charging body 5 and the second bracket 42. According to the above design, while the electronic device 6 is charged by the wireless charging body 5, the electronic device 6 on the adjustable bracket assembly 4 can be operated by the user through touch control, or an image played by a display screen of the electronic device 6 on the adjustable bracket assembly 4 can be viewed by the user. Under this circumstance, a viewing angle of the display screen of the electronic device 6 can provide the user with an acceptable viewing performance.

For securely placing the electronic device 6 on the wireless charging device, the wireless charging device further comprises an anti-slip structure 410. The anti-slip structure 410 is formed on a surface of the supporting part 415a of the first engaging structure 415. The electronic device 6 is supported on the anti-slip structure 410. Due to the friction provided by the anti-slip structure 410, the electronic device 6 may not fall down from the adjustable bracket assembly 4 easily. Moreover, the first bracket 41 further comprises a protrusion structure 411. The protrusion structure 411 is made of a rubbery material or any other material with high friction coefficient. The protrusion structure 411 is contacted with a supporting surface for providing an anti-slip effect to the region between the adjustable bracket assembly 4 and the supporting surface.

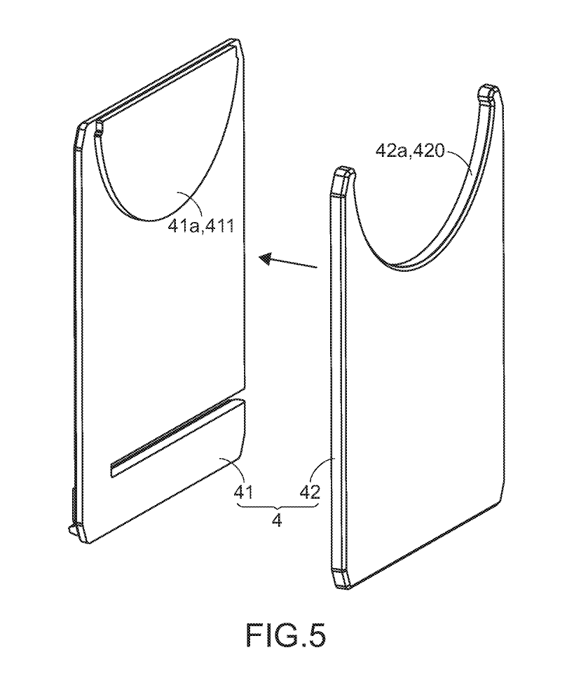

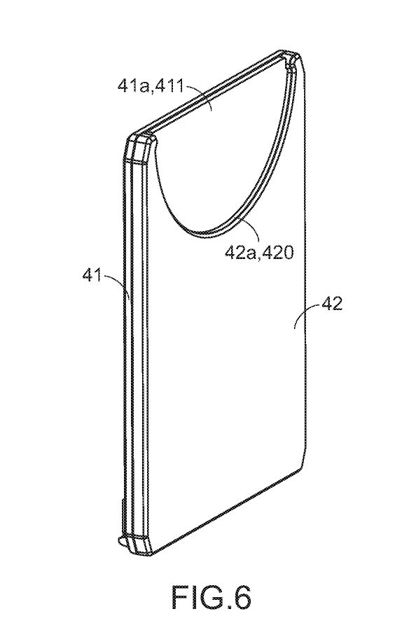

Hereinafter, the operations of the wireless charging device operated in the second assembling mode will be illustrated with reference to FIGS. 5 and 6. FIG. 5 is a schematic exploded view illustrating a wireless charging device in a second assembling mode. FIG. 6 is a schematic perspective view illustrating the assembled structure of the wireless charging device in the second assembling mode.

When the user want to travel and carry the wireless charging device, the first bracket 41 and the second bracket 42 of the adjustable bracket assembly 4 in the first assembling mode is firstly detached from each other, and then the wireless charging body 5 is detached from the receiving space 420 of the second bracket 42. Next, the first bracket 41 and the second bracket 42 are aligned with each other in a face-to-face manner, and first bracket 41 and the second bracket 42 are coupled with each other in the arrow direction of FIG. 5.

The first bracket 41 comprises a first coupling part 41a, and the second bracket 42 comprises a second coupling part 42a. As shown in

FIG. 6, when the first bracket 41 is stacked on the second bracket 42, the first coupling part 41a of the first bracket 41 and the second coupling part 42a of the second bracket 42 are coupled with each other. In this embodiment, the protrusion structure 411 is used as the first coupling part 41a, and the receiving space 420 is used as the second coupling part 42a. That is, when the first bracket 41 is stacked on the second bracket 42, the protrusion structure 411 of the first bracket 41 and the receiving space 420 of the second bracket 42 are coupled with each other. Consequently, the overall space occupied by the wireless charging device is largely reduced, and the adjustable bracket assembly 4 is in the easy-to-carry state. In the easy-to-carry state, the convenience of carrying the adjustable bracket assembly 4 is enhanced.

The way of coupling the protrusion structure 411 of the first bracket 41 with the receiving space 420 of the second bracket 42 in the easy-to-carry state of the adjustable bracket assembly 4 is presented herein for purpose of illustration and description only. However, those skilled in the art will readily observe that numerous modifications and alterations may be made while retaining the teachings of the invention. That is, the shapes of the first coupling part 41a and the second coupling part 42a are not restricted as long as the adjustable bracket assembly 4 can be assembled to be in the easy-to-carry state.

From the above descriptions, the present invention provides a wireless charging device. The wireless charging device comprises an adjustable bracket assembly and a wireless charging body. The adjustable bracket assembly comprises a first bracket and a second bracket. The first bracket and the second bracket are detachably coupled with each other. By changing the relative position between the first bracket and the second bracket, the positions of various electronic devices to be charged are adjustable. That is, the center of the inductive receiver coil of the electronic device can be aligned with the inductive transmitter coil of the wireless charging body. Due to the precise alignment between the inductive receiver coil and the inductive transmitter coil, the efficiency of charging the electronic device by the wireless charging device will be enhanced. On the other hand, the adjustable bracket assembly of the wireless charging device of the present invention may be selectively in a supporting state or an easy-to-carry state. Consequently, according to the practical requirements, the assembled structure of the adjustable bracket assembly may be adjusted. In other words, the use of the adjustable bracket assembly is more use-friendly and convenient.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wireless charging device for charging an electronic device, the electronic device comprising an inductive receiver coil, the wireless charging device comprising:
an adjustable bracket assembly for supporting the electronic device, wherein the adjustable bracket assembly comprises a first bracket and a second bracket; and
a wireless charging body disposed on the adjustable bracket assembly, and comprising an inductive transmitter coil,
wherein a relative position between the first bracket and the second bracket is adjustable, wherein when the relative position between the first bracket and the second bracket is adjusted, a position of the electronic device supported on the adjustable bracket assembly is changed, so that the inductive transmitter coil of the wireless charging body is aligned with the inductive receiver coil of the electronic device to perform a wireless charging operation.

2. The wireless charging device according to claim 1, wherein the first bracket comprises a first engaging structure, the second bracket comprises plural second engaging structures, and the first engaging structure is engageable with a specified second engaging structure of the plural second engaging structures, wherein an altitude of the electronic device supported on the adjustable bracket assembly is determined according to the specified second engaging structure.

3. The wireless charging device according to claim 2, wherein the first engaging structure comprises a supporting part and a notch part, and the plural second engaging structures are plural grooves, wherein when one of the plural grooves is clamped by sidewalls of the notch part, the supporting part of the first engaging structure is protruded over a surface of the second bracket, and an included angle is formed between the first bracket and the second bracket, so that the adjustable bracket assembly is in a supporting state.

4. The wireless charging device according to claim 3, wherein the plural grooves are in parallel with each other.

5. The wireless charging device according to claim 3, wherein the second bracket comprises a receiving space, and the wireless charging body is detachably disposed within the receiving space, wherein when the adjustable bracket assembly is in the supporting state to support the electronic device, the electronic device is supported by the supporting part of the first engaging structure, and the electronic device leans against the wireless charging body and at least one of the second bracket.

6. The wireless charging device according to claim 5, wherein the first bracket further comprises a protrusion structure, wherein when the first bracket is stacked on the second bracket, the protrusion structure of the first bracket and the receiving space of the second bracket are coupled with each other, so that the adjustable bracket assembly is in an easy-to-carry state.

7. The wireless charging device according to claim 6, further comprises an anti-slip structure, wherein the anti-slip structure is formed on a surface of the supporting part of the first engaging structure.

8. The wireless charging device according to claim 1, wherein the first bracket comprises a first coupling part, and the second bracket comprises a second coupling part, wherein when the first bracket is stacked on the second bracket, the first coupling part and the second coupling part are coupled with each other, so that the adjustable bracket assembly is in an easy-to-carry state.

9. The wireless charging device according to claim 8, wherein the first bracket comprises a protrusion structure, the second bracket comprises a receiving space, and the wireless charging body is detachably disposed within the receiving space, wherein the first coupling part is the protrusion structure, and the second coupling part is the receiving space.

10. The wireless charging device according to claim 1, wherein both of the first bracket and the second bracket are slabs.
